(19) United States
(12) Patent Application Publication
(10) Pub. No.: US 2013/0200283 A1
(43) Pub. Date: Aug. 8, 2013

(54) Solenoid Valve and Driver Assistance Device having such a Valve

(71) Applicant: Harald Speer, Freiberg (DE)

(72) Inventor: Harald Speer, Freiberg (DE)

(73) Assignee: ROBERT BOSCH GMBH, Stuttgart (DE)

(21) Appl. No.: 13/809,010

(22) PCT Filed: May 18, 2011
(86) PCT No.: PCT/EP2011/058072

§ 371 Date: Mar. 28, 2013

(30) Foreign Application Priority Data
Jul. 14, 2010 (DE) 10 2010 031 334.3

(51) Int. Cl. F16K 31/08

(52) U.S. Cl. CPC F16K 31/08
USPC 251/65

(57) ABSTRACT

A solenoid valve includes a magnet armature, a sealing element, an armature counterpart, and an intermediate element. The magnet armature is operatively connected to the sealing element to move the sealing element. The armature counterpart is arranged at an end face of the magnet armature. The intermediate element is configured to be brought into supporting contact with the armature counterpart and is supported in a guide opening of the magnet armature in an axially movable manner. The intermediate element is operatively connected to a spring element on a side of the intermediate element facing away from the armature counterpart. The supporting contact is established by a tilting bearing provided on the intermediate element.

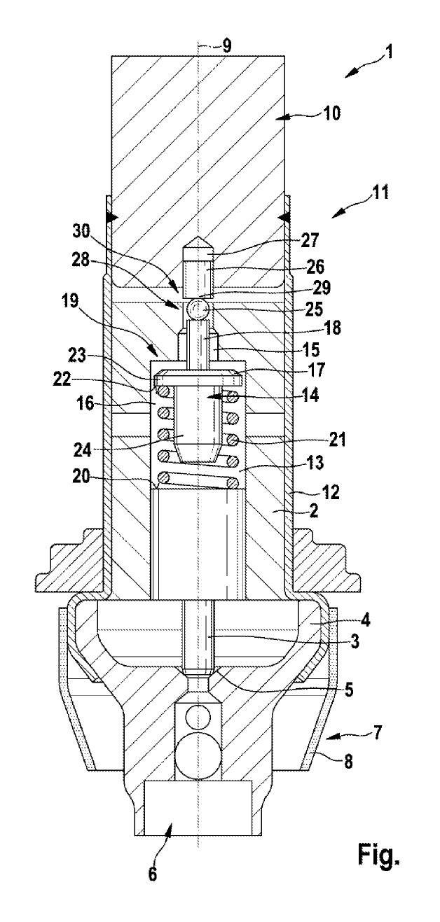

### PRIOR ART

The invention relates to a solenoid valve, having a magnet armature, which is operatively connected to a sealing element of the solenoid valve in order to displace said sealing element, and having an armature counterpart arranged at the end of the magnet armature, wherein an intermediate element that can be brought into supporting contact with the armature counterpart is supported in an axially movable manner in a guide recess in the magnet armature, and the intermediate element is operatively connected to a spring element on the side of the intermediate element facing away from the armature counterpart. The invention furthermore relates to a driver assistance device.

Solenoid valves of the type stated at the outset are known from the prior art. They are usually used for driver assistance devices, in particular ABS, TCS or ESP devices. The solenoid valve has the magnet armature, which is arranged in the solenoid valve in such a way that it can be displaced, in particular axially. The magnet armature is operatively connected to the sealing element of the solenoid valve, and therefore, when the magnet armature is displaced, the sealing element is also displaced. The sealing element is usually provided for the purpose of closing or exposing a valve opening of the solenoid valve. When the sealing element is arranged for the purpose of closing the valve opening, it is usually seated in a solenoid valve seat which is assigned both to the valve opening and to the sealing element. For example, the sealing element is introduced into a recess in the magnet armature and held in the latter, the recess preferably being provided on an end of the magnet armature facing away from the armature counterpart.

In addition to the magnet armature, the solenoid valve also has the armature counterpart, which is designed as a pole core, for example. The pole core is usually held in a fixed location relative to a housing of the solenoid valve, while the magnet armature can be displaced relative to the housing. To bring about this displacement, the magnet armature and the armature counterpart interact. In this arrangement, the armature counterpart has one or more coils, for example, while the magnet armature consists of a magnetizable or magnetic material. The armature counterpart is provided at the end of the magnet armature. The magnet armature and the armature counterpart are usually arranged relative to one another in such a way that they cannot come into connection with one another, irrespective of the displacement of the magnet armature. There is therefore a gap, referred to as the “air gap” or “working air gap”, between the magnet armature and the armature counterpart or between the end of the magnet armature facing the armature counterpart and the end of the armature counterpart facing the magnet armature. The size of the air gap is dependent on the position of the magnet armature in relation to the armature counterpart. The size of the air gap accordingly changes as the magnet armature is displaced.

The magnet armature and the armature counterpart together form an actuating device. The magnetic force that can be produced by this actuating device, which effects the displacement of the magnet armature, is characterized by the size of the working air gap. This means that the magnetic force is dependent on the size of the working air gap, with the magnetic force increasing very sharply—usually exponentially—as the size of the working air gap decreases. This sharp increase as the working air gap decreases in size makes it more difficult to achieve the ability for steady actuation and the proportionalization of the solenoid valve.

The solenoid valve usually has the spring element, which brings about a spring force that urges the magnet armature in the direction of a particular position. If the solenoid valve is a solenoid valve that is closed when deenergized, for example, the magnetic force is directed in such a way that the magnet armature is urged in the direction of a closed position, in which the sealing element is seated in the valve seat of the solenoid valve, with the result that the valve opening is closed. As an alternative, however, it is also possible for the solenoid valve to be designed as a solenoid valve that is open when deenergized, in which the spring force urges the magnet armature in the direction of an open position, in which the sealing element exposes the valve seat. In the production or assembly of the solenoid valve, it is necessary to set a preload for the spring element. In solenoid valves known from the prior art, this is associated with considerable effort. The setting of the spring force or preload can be simplified by arranging the intermediate element that can be brought into supporting contact with the armature counterpart in the guide recess in the magnet armature. In this case, the intermediate element is supported in a manner which allows axial movement, that is to say it can be displaced within the guide recess.

Accordingly, it is no longer necessary to arrange a spring element directly between the magnet armature and the armature counterpart. On the contrary, the operative connection between the magnet armature and the armature counterpart is established via the intermediate element, which is subjected to the spring force by the spring element. In the case of a solenoid valve that is closed when deenergized, for example, it is thus possible to bring about a situation where the magnet armature is urged away from the armature counterpart when the solenoid valve is not energized, that is to say where no magnetic force is produced by means of the actuating device or the magnetic force produced is lower than the spring force brought about by the spring element. The spring force or preload can be achieved, for example, by pressing the sealing element iteratively into the magnet armature if the sealing element is provided on the magnet armature in such a way that the spring element is supported on the sealing element on the side of the spring element facing away from the intermediate element. Consequently, the spring force in the assembled solenoid valve is produced by the clamping of the magnet armature, of the sealing element and of the intermediate element between the valve seat and the armature counterpart. One preferred possibility is for the spring element to be arranged in the guide recess.

However, frictional forces arise between the intermediate element and the magnet armature with such an embodiment of the solenoid valve. These are caused, for example, by transverse forces imposed on the intermediate element by the spring element and/or by tilting of the intermediate element relative to the armature counterpart. The latter occurs, for example, where the magnet armature tilts relative to the armature counterpart due, in particular, to tolerances, or where the armature counterpart is arranged askew. The effect of the transverse force on the guidance behavior of the magnet armature is further intensified by an increasing surface roughness of the contact surfaces on the armature counterpart and/or on the intermediate element. The occurrence of the frictional forces, however, causes a reduction in the efficiency of the solenoid valve and, in particular, entails an increase in the minimum achievable actuating times.

### DISCLOSURE OF THE INVENTION

Compared with the above, the solenoid valve having the features of claim 1 has the advantage that the frictional forces arising between the intermediate element and the armature counterpart are reduced. According to the invention, this is achieved by virtue of the fact that the supporting contact is established via a tilting bearing provided on the intermediate element. This means that the intermediate element comes into contact with or rests on the armature counterpart in such a way that tilting or pivoting of the intermediate element relative to the armature counterpart is permitted or assisted. Here, the tilting or pivoting takes place, in particular, about at least one axis, which is substantially perpendicular to a longitudinal axis of the solenoid valve. The axis preferably lies in the end of the armature counterpart or of a counterelement assigned to the armature counterpart. This makes it possible to eliminate the occurrence of any transverse forces due to tilting of the intermediate element relative to the magnet armature or the armature counterpart. At least, however, the transverse forces which do occur are reduced in comparison with a conventional solenoid valve design. Thus, the frictional forces between the intermediate element and the magnet armature are also reduced. In principle, the tilting bearing can be of any desired design. All that is required is that it should permit the above-described tilting of the intermediate element relative to the armature counterpart in such a way that such tilting does not cause or promote the occurrence of the transverse forces.

A development of the invention provides for the intermediate element to have a contact region of reduced cross section on the side of the intermediate element facing the armature counterpart in order to form the tilting bearing and, in particular, to be in the form of a ball, a spherical segment or a cone in the region of the contact region. The term “contact region of reduced cross section” is intended, in particular, to mean that the cross section of the intermediate element decreases in the direction of the armature counterpart, e.g. continuously. The contact region in which the intermediate element enters into supporting contact with the armature counterpart to form the tilting bearing accordingly has a smaller cross section than those regions of the intermediate element which face away from the armature counterpart. In the case of a continuous reduction in the cross section of the intermediate element, the shape of the intermediate element is, in particular, that of a cone. Thus, the intermediate element is of conical configuration in the region of the contact region. However, a configuration of the intermediate element in the form of a ball or a spherical segment in the region of the contact region has also proven advantageous.

A development of the invention provides for the intermediate element to consist at least of a main body and of a supporting part, which is connected to the main body and has the contact region. In this case, the main body and the supporting part are preferably connected securely to one another. In this case, provision is usually made for only the supporting part to have the contact region of reduced cross section, i.e. said region is not present on the main body. By way of example, this can be achieved by designing the supporting part as a ball which is secured on the main body, in particular welded to the latter. Because the contact region is on the supporting part, it is particularly advantageous if the supporting part is composed of a sufficiently hard material, in particular hardened metal. The two-part or multi-part configuration of the intermediate element furthermore makes it possible to make the main body in a low-cost production process. The customary practice in the case of known solenoid valves is to make the intermediate element as a turned part. However, if the supporting part is separate from the main body, it is also possible, for example, for the latter to be produced by means of a forming process, in particular cold-forming. In this way, a significant reduction in costs can be achieved.

A development of the invention provides for the armature counterpart to have a counterelement, which interacts with the intermediate element to establish the supporting contact. It is thus envisaged that the intermediate element should not rest directly on a main body of the armature counterpart but instead on the counterelement of the armature counterpart in order to establish the supporting contact. The counterelement is, for example, a projection on the armature counterpart extending in the direction of the magnet armature or of the intermediate element.

A development of the invention provides for the counterelement to engage in the armature counterpart at least over a certain area. In this way, the counterelement can be secured on the armature counterpart. In particular, adjustment of the solenoid valve can be provided by providing for the counterelement to engage in the armature counterpart with a clamping action, the magnitude of the clamping force being such that no displacement of the counterelement in relation to the armature counterpart is to be expected during normal operation of the solenoid valve. Accordingly, it is only possible for the counterelement to be introduced into or moved out of the armature counterpart through the influence of an external force when adjusting the solenoid valve. Through the introduction of the counterelement into the armature counterpart by different amounts in this way, it is thus possible to perform adjustment of the solenoid valve, in particular adjustment of the preload.

A development of the invention provides for the intermediate element to reach through a through opening, which is provided on the side of the magnet armature which faces the armature counterpart, wherein the through opening forms a radial guide for the intermediate element. In addition to the guide recess, the through opening is thus formed in the magnet armature. Both the guide recess and the through opening are preferably formed by the same recess, for which purpose this recess is in the form of a stepped bore in the magnet armature, for example. In order to provide the radial guidance of the intermediate element by means of the through opening, there is preferably a region of the intermediate element in the through opening which is larger in the axial direction of the intermediate element than that in the guide recess. The through opening reaches through the end of the magnet armature which faces the armature counterpart, for example. The through opening is matched to the dimensions of the intermediate element in such a way that the intermediate element can be moved easily in the axial direction but is held securely in the radial direction.

For example, the radial guide is formed by making the dimensions of the intermediate element correspond substantially to the dimensions of the through opening, with the result that the intermediate element rests on the wall of the through opening. However, it is particularly advantageous if the intermediate element has dimensions corresponding to the dimensions of the through opening only over a certain area, with the result that the radial guide is present only in one region of the intermediate element. It is accordingly not envisaged that the intermediate element should rest all the way through on the wall of the through opening to form the radial guide but that the latter should be provided only for one region of the intermediate element extending in the axial direction. In this case, for example, the main body of the intermediate element can have a smaller cross section than the supporting part which is connected to the main body and has the contact region, and the dimensions of the supporting part—when viewed in cross section—can correspond to the dimensions of the through opening. In such a configuration, the radial guide is provided by physical contact between the supporting part and the wall of the through opening, while the main body is not in contact with the wall.

A development of the invention provides for the cross section of the through opening to be small in comparison with the cross section of the guide recess. In this way, an end stop for the intermediate element is formed in the magnet armature, limiting the movement of the latter in the axial direction. For this purpose, a region of the intermediate element facing away from the armature counterpart is larger than the through opening, preventing it from passing through said opening.

A development of the invention provides for the spring element to reach around the intermediate element at least over a certain area, preferably with a clamping action. Particularly in order to support the spring element in the radial direction, provision can be made for the spring element to reach around the intermediate element at least in a certain area. Accordingly, the spring element is present in the radial direction between a wall of the guide recess and the intermediate element. In this case, the spring element is preferably designed as a spiral spring. In addition, provision can be made for the spring element to reach around the intermediate element with a clamping action, thus enabling the spring force to be imposed on the intermediate element through the clamping action by the spring element reaching around the latter.

A development of the invention provides for the spring element to engage on the intermediate element via a retaining projection provided on the intermediate element. The intermediate element accordingly has the retaining projection, which is present in the radial direction, for example. This is provided, in particular, if the spring element reaches around the intermediate element at least over a certain area in the radial direction. In this case, the fact that the spring element reaches around the intermediate element is exploited to support the spring element, while the spring force is transmitted to the intermediate element via the retaining projection.

The invention furthermore relates to a driver assistance device, in particular an ABS, TCS or ESP device, having at least one solenoid valve, in particular as explained above, wherein the solenoid valve has a magnet armature, which is operatively connected to a sealing element of the solenoid valve in order to displace said element, and an armature counterpart arranged at the end of the magnet armature, wherein an intermediate element that can be brought into supporting contact with the armature counterpart is supported in an axially movable manner in a guide recess of the magnet armature, and the intermediate element is operatively connected to a spring element on the side of the intermediate element facing away from the armature counterpart. In this case, provision is made for the supporting contact to be established via a tilting bearing provided on the intermediate element.

The invention is explained in greater detail with reference to the illustrative embodiments shown in the drawing without restricting the invention. In the drawing, the single

FIGURE shows a sectioned side view of a solenoid valve.

The FIGURE shows a solenoid valve 1, which is part of a driver assistance device, for example (not shown here). The solenoid valve 1 has a magnet armature 2, which is operatively connected to a sealing element 3 of the solenoid valve 1. The sealing element 3 interacts with a valve seat 5 formed in a valve body 4 in order to open and interrupt a flow connection between an inlet port 6 and an outlet port 7 of the solenoid valve 1. In the illustrative embodiment shown here, the outlet port is assigned a filter 8. In addition or as an alternative, it is, of course, also possible to assign a filter to the inlet port 6 (not shown here). The solenoid valve 1 illustrated here is designed to provide an arrangement of the inlet port 6 and the outlet port 7 for axial inflow and radial outflow (relative to a longitudinal axis 9 of the solenoid valve 1). It is self-evident, however, that the direction of inflow and the direction of outflow provided are a matter of free choice.

In addition to the magnet armature 2, the solenoid valve 1 has an armature counterpart 10, which, together with the magnet armature 2, forms an actuating device 11 for the solenoid valve 1. The armature counterpart 10 is designed as a pole core, for example, and has at least one electric coil, making it possible to apply a magnetic force to the magnet armature 2 by means of the armature counterpart 10 by applying a voltage across the coil (i.e. by energizing the solenoid valve 1). The magnet armature 2 is supported in a manner which allows it to be displaced axially relative to the longitudinal axis 9, support being provided, in particular, by means of a housing 12 of the solenoid valve 1. In this arrangement, the armature counterpart 10 and the valve body 4 are also held in a fixed location on the housing 12. Under the influence of the magnetic force produced by means of the armature counterpart 10, the magnet armature 2 can thus be displaced in the axial direction relative to the magnet armature 2 and to the valve body 4. The solenoid valve 1 illustrated in the FIGURE is a solenoid valve 1 that is closed when deenergized. This means that the sealing element 3 is seated in a sealing manner in the valve seat 5 as long as the solenoid valve 1 is not energized, i.e. while no magnetic force is being produced by means of the armature counterpart 10.

In order to improve adjustability during the production of the solenoid valve 1, an intermediate element 14 is arranged in a guide recess 13 in the magnet armature 2. In this case, the intermediate element 14 is supported in a manner which allows it to be moved axially, and it can enter into supporting contact with the armature counterpart 10. In addition to the guide recess 13, the magnet armature 2 has a through opening 15, the guide recess 13 and the through opening 15 preferably being formed by a stepped bore 16. The through opening 15 has a smaller cross section than the guide recess 13, that is to say, in particular, a smaller diameter. At the same time, the intermediate element 14 consists of a guide section 17 and a penetration section 18. The guide section 17 is arranged in the guide recess 13, while the penetration section 18 is situated in the through opening 15, at least over a certain area. In this case, the guide section 18 has a larger cross section, in particular a larger diameter, than the penetration section 18. Thus, an end stop 19 for the intermediate element 14 is formed in the magnet armature 2. The end stop 19 prevents the intermediate element 14 from coming out of the magnet armature 2 or stepped bore 16 in the direction of the armature counterpart 10.

By virtue of the small dimensions of the penetration section 18 in comparison with the guide section 17, virtually the entire pole surface (in the form of the surface of the end of the armature counterpart 10) is available for transmitting the magnetic force.

The sealing element 3 is introduced into the stepped bore 16 on the side of the magnet armature 2 facing away from the intermediate element 14. In this case, the sealing element 3 is preferably pressed into the stepped bore 16, with the result that it is held in the latter with a clamping action. On its side facing away from the valve seat 5, the sealing element 3 has a supporting surface 20 for a spring element 21, which is arranged between the sealing element 3 and the intermediate element 14. In this case, the intermediate element 14 has a bearing surface 22 for the spring element 21. The bearing surface 22 projects at a retaining projection 23, which extends outward in a radial direction, starting from a main body 24 of the intermediate element 14. The spring element 21 reaches around the intermediate element 14 in the radial direction, at least over a certain area, with the result that the spring element 21 is arranged between the intermediate element 14 and the wall of the stepped bore 16 or guide recess 13 in the radial direction. In this way, axial guidance of the intermediate element 14 and/or of the spring element 21 can be achieved. It is preferred here if the outside diameter of the spring element 21 is less than the diameter of the retaining projection 23 and smaller than the diameter of the guide recess 13. It is furthermore advantageous if the diameter of the retaining projection 23 corresponds substantially to the diameter of the guide recess 13, with the result that the retaining projection 23 forms a radial guide for the intermediate element 14 or main body 24 thereof together with the wall of the guide recess.

In addition to the main body 24, the intermediate element 14 has a supporting part 25, which is secured on the main body 24, in particular being welded thereto. The supporting part 25 is in the form of a ball but, as an alternative, a hemispherical configuration or a conical configuration is also possible. In the former case, the round side faces the armature counterpart 10. Via the supporting part 25, the supporting contact is made with the armature counterpart 10. In this arrangement, the supporting part 25 enters into physical contact with a counterelement 26, which is pressed into a recess 27 in the armature counterpart 10 and is thus held on the latter with a clamping action. By pressing in the counterelement 26 iteratively, the preload of the spring element 21 in the solenoid valve 1 can thus be adjusted during the production of the latter. In addition or as an alternative, the preload of the spring element 21, which is designed as a spiral spring for example, in the embodiment of the solenoid valve 1 according to the invention, can also be adjusted by pressing the sealing element 3 into the magnet armature 2. It is advantageous if the supporting part 25 and/or the counterelement 26 are composed of a hardened material, in particular hardened metal. In this way, good durability and operational reliability of the solenoid valve 1 is ensured.

In the region of the through opening 15 in which the supporting part 25 is present, the dimensions of the through opening 15 are reduced, in particular are matched to the dimensions of the supporting part 25 in such a way that a radial guide 28 is formed. At the same time, the dimensions of the main body—when viewed in cross section—are smaller than those of the supporting part 25. Thus, only the supporting part 25 can come into contact with the wall of the through opening 15 to form the radial guide, while this is not the case for other regions of the penetration section 18. In this way, the frictional forces between the intermediate element 14 and the magnet armature 2, which occur during the displacement of the two elements relative to one another, are reduced.

At the same time, the supporting part 25 forms a contact region 29 of reduced cross section, which can enter into physical contact with the counterelement 26 to establish supporting contact between the intermediate element 14 and the armature counterpart 10. The reduction in the cross section of the contact region 29 gives rise to a tilting bearing 30, via which supporting contact is established. The tilting bearing 30 enables the intermediate element 14 and the armature counterpart to tilt relative to one another without giving rise to transverse forces that increase the frictional forces between the intermediate element 14 and the magnet armature 2. The tilting bearing 30 too thus serves to reduce said frictional forces.

The spring element 21 brings about a spring force acting on the intermediate element 14, the spring element being supported on the sealing element 3, which is arranged in a fixed location relative to the magnet armature 2. The spring force urges the intermediate element 14 in the direction of the armature counterpart 10. If the solenoid valve 1 is energized, the corresponding magnetic force, which is directed in the direction of the armature counterpart 10 in the illustrative embodiment shown here, acts on the magnet armature 2, and the magnet armature 2 is thus moved toward the armature counterpart 10. As soon as the magnet armature 2 reaches an axial position relative to the armature counterpart 10 in which the intermediate element 14 is in physical contact or supporting contact with the armature counterpart 10, the intermediate element 14 is displaced into the guide recess 13, i.e. toward the sealing element 3. During this process, the spring element 21 is subjected to a further load. If the magnetic force disappears, the spring force has the effect that the magnet armature 2 is urged away from the armature counterpart 10 again. In the embodiment proposed here, therefore, the return of the magnet armature 2 is likewise achieved by means of the intermediate element 14, with the intermediate element 14 remaining in continuous supporting contact with the armature counterpart 10. However, it is likewise possible for provision to be made for another spring element (not shown here) to be used for return. In this case, the intermediate element 14 can be spaced apart from the armature counterpart 10 in at least one position of the magnet armature 2 and only enter into supporting contact with the armature counterpart 10 when the magnet armature 2 and the armature counterpart 10 move toward one another.

1. A solenoid valve comprising:
a sealing element;
a magnet armature is operatively connected to the sealing element of the solenoid valve to displace said sealing element;
an armature counterpart arranged at an end of the magnet armature; and
an intermediate element configured to be brought into supporting contact with the armature counterpart, wherein:
the intermediate element is supported in an axially movable manner in a guide recess in the magnet armature,
the intermediate element is operatively connected to a spring element on a side of the intermediate element facing away from the armature counterpart, and
the supporting contact is established via a tilting bearing provided on the intermediate element.

2. The solenoid valve as claimed in claim 1, wherein:
the intermediate element has a contact region of with a reduced cross section on a side of the intermediate element facing the armature counterpart configured to form the tilting bearing and,
the intermediate element is in the form of one of a ball, a spherical segment or a cone in a region of the contact region.

3. The solenoid valve as claimed in claim 1, wherein:
the intermediate element includes a main body and a supporting part, and
the supporting part is connected to the main body and includes the contact region.

4. The solenoid valve as claimed in claim 1, wherein the armature counterpart has a counterelement configured to interact with the intermediate element to establish the supporting contact.

5. The solenoid valve as claimed in claim 1, wherein the counterelement engages in the armature counterpart at least over a certain area.

6. The solenoid valve as claimed in claim 1, wherein:
the magnet armature includes a through opening on a side of the magnet armature which faces the armature counterpart,
the intermediate element reaches through the through opening, and
the through opening forms a radial guide for the intermediate element.

7. The solenoid valve as claimed in claim 6, wherein a cross section of the through opening is small relative to a cross section of the guide recess.

8. The solenoid valve as claimed in claim 1, wherein the spring element reaches around the intermediate element at least over a certain area with a clamping action.

9. The solenoid valve as claimed in claim 1, wherein the spring element engages on the intermediate element via a retaining projection provided on the intermediate element.

10. A driver assistance device, comprising:
at least one solenoid valve including:
a sealing element;
a magnet armature operatively connected to the sealing element to displace said sealing element;
an armature counterpart arranged at an end of the magnet armature; and
an intermediate element configured to be brought into supporting contact with the armature counterpart, wherein:
the intermediate element is supported in an axially movable manner in a guide recess of the magnet armature,
the intermediate element is operatively connected to a spring element on a side of the intermediate element facing away from the armature counterpart, and
the supporting contact is established via a tilting bearing provided on the intermediate element.
